(19) United States
(12) Patent Application Publication
(10) Pub. No.: US 2021/0364613 A1
(43) Pub. Date: Nov. 25, 2021

(54) DISTANCE MEASURING DEVICE AND LIGHT EMISSION DIAGNOSIS METHOD FOR LIGHT SOURCE

(71) Applicant: Hitachi-LG Data Storage, Inc., Tokyo (JP)

(72) Inventors: Katsuhiko IZUMI, Tokyo (JP); Takeshi IMAI, Tokyo (JP)

(21) Appl. No.: 17/214,972

(22) Filed: Mar. 29, 2021

(30) Foreign Application Priority Data
May 20, 2020 (JP) 2020-088023

(51) Int. Cl. G01S 7/497; G01S 17/894

(52) U.S. Cl. CPC G01S 7/497; G01S 17/894

(57) ABSTRACT

A distance measuring device includes: a light emitting unit that irradiates a subject; a light receiving unit that receives reflected light; a distance calculating unit that calculates a distance to the subject; a luminance calculating unit that calculates a luminance of the subject; an image processing unit that generates a distance image and a luminance image of the subject; a screen luminance calculating unit that calculates a screen luminance value from the luminance image; and a light source light emission determining unit that determines whether a light emission state of the light source is normal or abnormal. The light source light emission determining unit acquires a screen luminance value at the time of turning on the light source in a first frame, a screen luminance value at the time of turning off the light source in a second frame, and compares the screen luminance values of each of the frames.

### CROSS-REFERENCE TO RELATED APPLICATION

The present application claims priority from Japanese application JP2020-088023, filed on May 20, 2020, the contents of which is hereby incorporated by reference into this application.

### BACKGROUND OF THE INVENTION

### 1. Field of the Invention

The present invention relates to a distance measuring device outputting a distance image of the position of a subject and a light emission diagnosis method for a light source used therein.

### 2. Description of the Related Art

In a technology such as a Time-of-Flight method (hereinafter, referred to as a TOF method) that measures a distance to a subject, on the basis of a light transmission time, a distance measuring device outputting the measured distance as a distance image is known. In the distance measuring device, it is necessary to maintain the accuracy of a measurement distance. For example, in a use application in which the movement of a figure in a shop is continuously sensed, in a case where the accuracy of the measurement distance is degraded, the movement (the flow) of the figure is not capable of being correctly detected. Regarding such a problem of a measurement accuracy, in a technology disclosed in JP 2010-190675 A, a configuration is proposed in which light is emitted from a plurality of light sources by sequentially switching the plurality of light sources, a plurality of distance images to a subject are generated, and then, in the plurality of distance images, a distance image generated by using an image with the largest amount of received light in the imaging is selected.

In the distance measuring device, a light source emitting irradiation light for measuring a distance (such as a laser or an LED) is provided, and in a case where a failure occurs such that the light source does not emit light during the operation of the device, the distance is not capable of being correctly measured. At this time, in a case where there is predetermined or higher return light, a distance value is output even in a case where a failure occurs in the light source, and thus, a light emission state of the light source is not capable of being determined by whether or not the distance can be measured. For this reason, in the distance measuring device, it has been required to have a function of accurately diagnosing the light emission state of the light source (the presence or absence of a light emission failure). In particular, in the case of a system in which the distance measuring device is controlled from a remote location, it is necessary that the light emission state of the light source can be diagnosed in the remote location.

In this regard, in JP 2010-190675 A described above, light is sequentially emitted from the plurality of light sources, and the distance image with the largest amount of received light is selected, and thus, the light emission states of each of the light sources are not independently evaluated. Accordingly, the selected distance image may not satisfy a desired accuracy. In addition, in a case where there is only one light source used in the distance measuring device, there is only one distance image, and thus, the technology disclosed in JP 2010-190675 A is not capable of being applied.

### SUMMARY OF THE INVENTION

An object of the invention is to provide a distance measuring device and a light emission diagnosis method in which a light emission state of a light source used in the distance measuring device can be easily diagnosed.

A distance measuring device according to the invention, includes: a light emitting unit that allows a light source to emit light and irradiates the subject with the light; a light receiving unit that receives reflected light from the subject; a distance calculating unit that calculates a distance to the subject from a detection signal of the light receiving unit; a luminance calculating unit that calculates a luminance of the subject from the detection signal of the light receiving unit; an image processing unit that generates a distance image of the subject from the distance calculated by the distance calculating unit and generates a luminance image of the subject from the luminance calculated by the luminance calculating unit; a screen luminance calculating unit that calculates screen luminance values of each frame from the generated luminance image; and a light source light emission determining unit that determines whether a light emission state of the light source is normal or abnormal by using the screen luminance values of each of the frames. The light source light emission determining unit determines the light emission state of the light source by acquiring a screen luminance value L1 at the time of turning on the light source in a first frame, by acquiring a screen luminance value L2 at the time of turning off the light source in a second frame, and by comparing the screen luminance values L1 and L2 of the first frame and the second frame.

In addition, a light emission diagnosis method for a light source used in a distance measuring device according to the invention, includes: a step of receiving reflected light from a subject by turning on the light source to generate a luminance image of the subject in a first frame; a step of receiving the reflected light from the subject by turning off the light source to generate the luminance image of the subject in a second frame; a step of acquiring screen luminance values L1 and L2 of each of the frames from the generated luminance images; and a step of determining whether a light emission state of the light source is normal or abnormal by using the screen luminance values L1 and L2 of each of the frames. It is determined that there is the subject in the luminance image when both of the screen luminance values L1 and L2 of the first frame and the second frame are greater than a threshold value Th1, and it is determined that the light emission state of the light source is normal when the screen luminance value L1 of the first frame is greater than a threshold value Th2, and it is determined that the light emission state of the light source is abnormal when the screen luminance value L1 is less than the threshold value Th2.

According to the invention, a light emission state of a light source used in a distance measuring device can be easily diagnosed even from a remote location, and thus, the accuracy of a measurement distance is maintained, and the convenience of a user is improved.

### BRIEF DESCRIPTION OF THE DRAWINGS

FIG. 1 is a configuration diagram of a distance measuring device in Example 1;

FIG. 2A is a diagram describing principle of distance measurement using a TOF method;

FIG. 2B is a diagram describing principle of distance measurement using a TOF method;

FIG. 3A is a diagram illustrating a relationship between a light emission state of a light source and luminance image output;

FIG. 3B is a diagram illustrating a relationship between a light emission state of a light source and luminance image output;

FIG. 3C is a diagram illustrating a relationship between a light emission state of a light source and luminance image output;

FIG. 3D is a diagram illustrating a relationship between a light emission state of a light source and luminance image output;

FIG. 4A is a diagram illustrating a relationship between a light emission state of a light source and a screen luminance value;

FIG. 4B is a diagram in which screen luminance values are rearranged in descending order;

FIG. 4C is a diagram describing setting for determination threshold values Th1 and Th2;

FIG. 5 is a flowchart illustrating determination processing of a light emission state of a light source in Example 1;

FIG. 6 is a diagram illustrating a distance measuring device and an operation state thereof in Example 2;

FIG. 7A is a diagram illustrating a relationship between a light emission state of a light source and a screen luminance value (a first step);

FIG. 7B is a diagram in which screen luminance values are rearranged in descending order;

FIG. 7C is a diagram describing setting for a determination threshold value Th3;

FIG. 8A is a diagram illustrating a relationship between a light emission state of a light source and a screen luminance value (a second step);

FIG. 8B is a diagram in which screen luminance values are rearranged in descending order;

FIG. 8C is a diagram describing setting for a determination threshold value Th4; and

FIG. 9 is a flowchart illustrating determination processing of a light emission state of a light source in Example 2.

### DETAILED DESCRIPTION OF THE PREFERRED EMBODIMENTS

Hereinafter, an embodiment of the invention will be described with reference to the drawings.

### Example 1

In Example 1, a case will be described in which one light source is used in a distance measuring device.

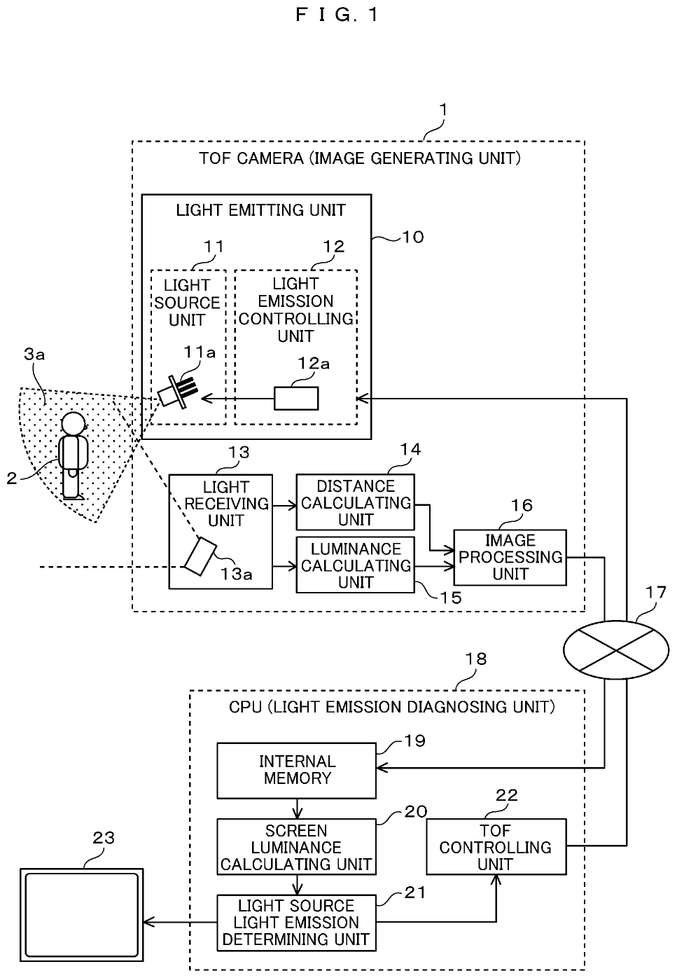

FIG. 1 is a configuration diagram of a distance measuring device in Example 1. In the distance measuring device, a distance to a subject such as a figure is measured by a Time of Flight method (a TOF method), and the measured distances to each part of the subject, for example, are displayed by color and are output as a distance image. For example, a figure is set to a measurement target, and a movement locus thereof is output as an image, and thus, flow analysis or the like can be performed.

The distance measuring device includes a TOF camera 1 generating the distance image with the TOF method and a luminance image of the subject (hereinafter, also referred to as an image generating unit), and a CPU 18 controlling the TOF camera 1, and both are connected through a network 17. Here, the CPU 18 not only analyzes the distance image or the luminance image that is generated by the TOF camera 1 and displays the distance image or the luminance image on a display device 23, but also has a function of diagnosing a light emission state of a light source 11a used in the TOF camera 1, and hereinafter, will also be referred to as a light emission diagnosing unit.

First, the configuration of the TOF camera 1 (the image generating unit) will be described. The TOF camera 1 includes a light emitting unit 10 that irradiates a subject 2 with pulsed light, a light receiving unit 13 that receives the pulsed light reflected from the subject 2, a distance calculating unit 14 that calculates a distance to the subject 2 from a detection signal of the light receiving unit 13, a luminance calculating unit 15 that calculates the luminance of the subject 2, and an image processing unit 16 that generates the distance image of the subject 2 on the basis of distance data output from the distance calculating unit 14 and generates the luminance image of the subject 2 on the basis of luminance data output from the luminance calculating unit 15.

The light emitting unit 10 includes a light source unit 11 in which a light source 11a allowing irradiation light 3a to exit, such as a laser diode (LD), a surface-emitting laser, or a light emission diode (LED), is disposed, and a light emission controlling unit 12 that turns on or turns off the light source 11a or adjusts a light emission amount. Note that, infrared light is used in the irradiation light. The light emission controlling unit 12 includes a light source driving circuit 12a, and controls the light source driving circuit 12a, in accordance with a command from the external CPU 18. The irradiation light 3a from the light source 11a exits toward a region in which there is the subject 2.

The light reflected from the subject 2 is incident on the light receiving unit 13. The light receiving unit 13 includes a two-dimensional sensor 13a such as a CCD sensor or a CMOS sensor, and a signal subjected to photoelectric conversion by the two-dimensional sensor 13a is sent to the distance calculating unit 14 and the luminance calculating unit 15. In the distance calculating unit 14, the distance to the subject is calculated, and the distance data to the subject 2 is sent to the image processing unit 16. In the luminance calculating unit 15, the luminance is calculated from a light amount of the reflected light from the subject 2, and the luminance data of the subject 2 is sent to the image processing unit 16. The image processing unit 16 is capable of performing colorization processing of changing a color phase of a subject image, on the basis of the distance data, and is also capable of performing processing of changing brightness, contrast, and the like with respect to the luminance data. The data of the distance image or the luminance image subjected to image processing is transmitted to the CPU 18 through the network 17.

In the CPU 18, the distance image data or the luminance image data transmitted from the TOF camera 1 is stored in an internal memory 19 for each frame. Then, the distance image or the luminance image is displayed on the display device 23, and thus, a user is capable of easily recognizing the position (the distance) or the shape (the posture), and the movement locus (the flow) of the subject such as a figure by viewing the colorized distance image.

On the other hand, the CPU 18 has a light emission diagnosis function. A screen luminance calculating unit 20 calculates screen luminance values of each of the frames by the luminance image data stored in the internal memory 19. The screen luminance value is a sum (or a pixel average value) of luminance values detected in one pixel of one frame. Alternatively, the screen luminance value may be calculated by cutting out a part of a screen having the same visual field position instead of the entire screen.

A light source light emission determining unit 21 determines the light emission state of the light source 11a of the TOF camera 1, that is, determines whether the light emission of the light source 11a is normal or abnormal (non-light emission or a small light emission amount) by using the screen luminance values of each of the frames. The determination result and the luminance image data are displayed on the display device 23, and can be transferred to the user (a manager of the device).

A TOF controlling unit 22 sends a control signal to the TOF camera 1, and performs control such that the light emitting unit 10 (the light source 11a) is turned on/turned off in order to acquire the distance image or the luminance image. In addition, in order to diagnose the light emission state of the light source 11a, the control signal for switching turning-on/turning-off of the light source is sent for each of the frames.

In the above description, both of a general distance measuring operation of the TOF camera 1 and a light emission diagnosis operation of the light source are performed by one CPU 18, but the distance measuring operation and the light emission diagnosis operation may be executed by different CPUs.

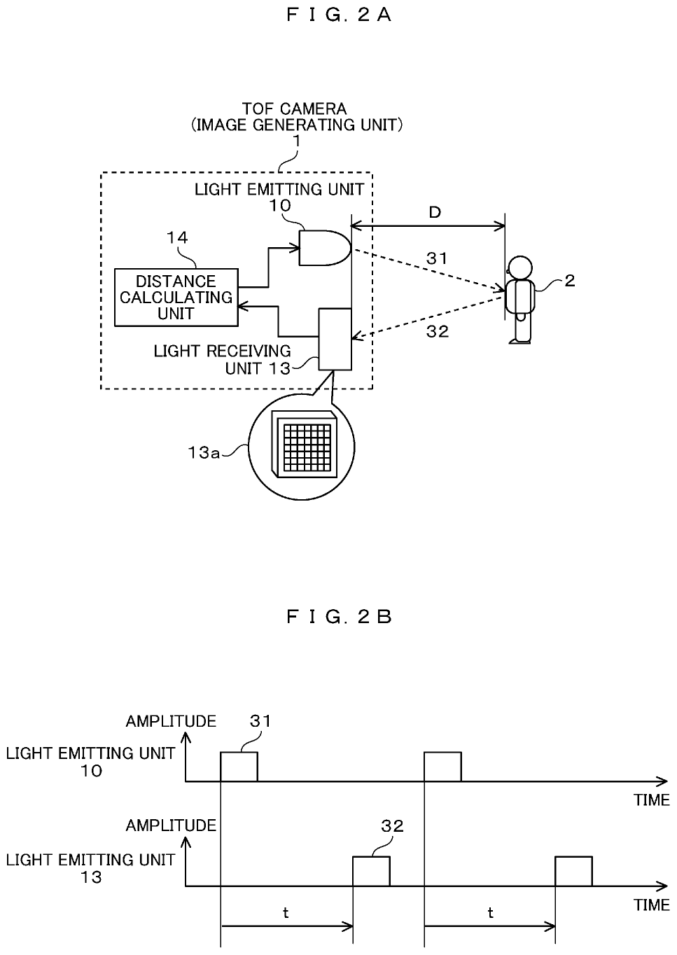

FIG. 2A and FIG. 2B are diagrams describing the principle of distance measurement using a TOF method. In the TOF method, a distance is calculated by a temporal difference between a light emission signal and a light reception signal.

FIG. 2A is a diagram illustrating a relationship between the TOF camera 1 and the subject 2 (for example, a figure). The TOF camera 1 allows an irradiation pulse 31 for measuring a distance to exit to the subject 2 from the light emitting unit 10. The irradiation pulse 31 is reflected on the subject 2, becomes a reflected light pulse 32, and is received by the two-dimensional sensor 13a of the light receiving unit 13. A distance to the subject 2 from the light emitting unit 10 and the light receiving unit 13 is set to D. Here, in a case where a temporal difference between a time when the light emitting unit 10 allows the irradiation pulse 31 to exit and a time when the light receiving unit 13 receives the reflected light pulse 32 is set to t, the distance D to the subject 2 is obtained by D=c×t/2 (c is a light speed).

FIG. 2B is a diagram illustrating the measurement of the temporal difference t. The distance calculating unit 14 measures the temporal difference t from a timing when the irradiation pulse 31 exits from the light emitting unit 10 and a timing when the reflected light pulse 32 is received by the light receiving unit 13, and calculates the distance D to the subject 2 from the expression described above. In addition, a difference in each part of the subject, that is, a concavo-convex shape of the subject can be obtained from a shift in a light receiving timing at each pixel position in the two-dimensional sensor 13a.

Hereinafter, the diagnosis method of the light emission state of the light source in this example will be described.

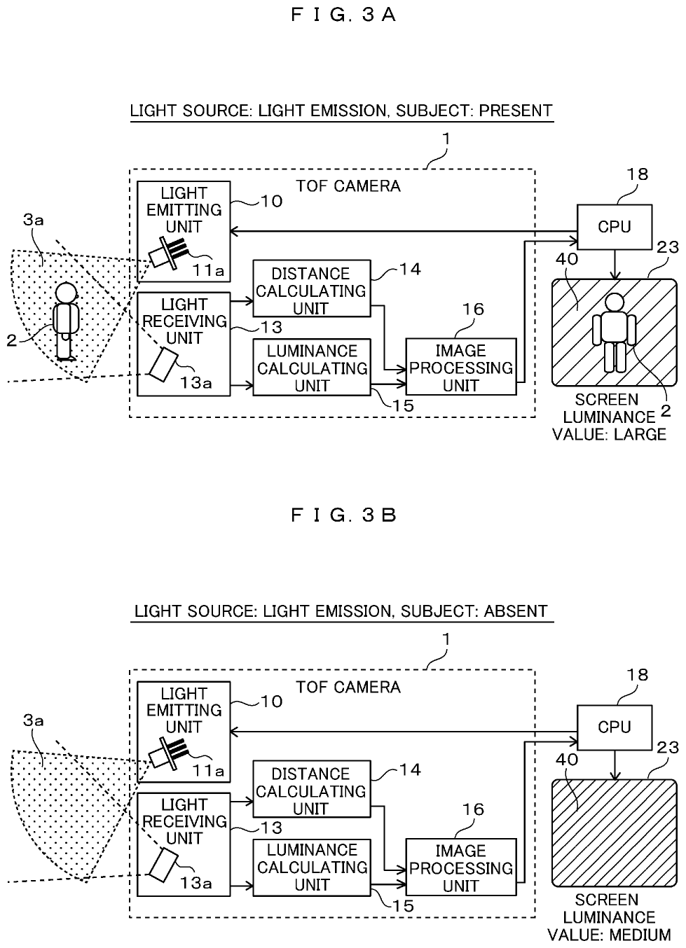

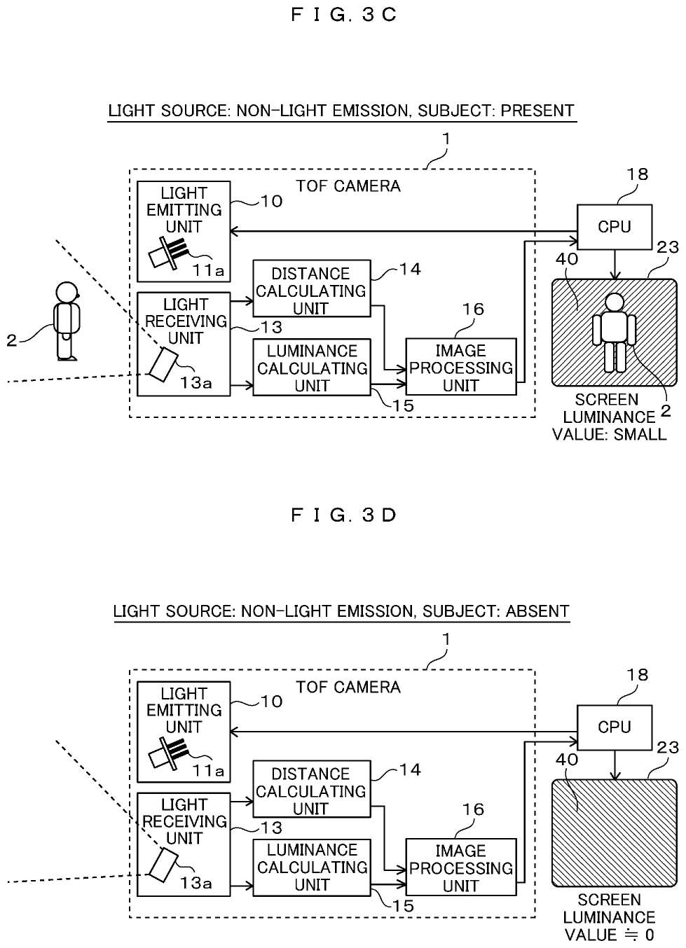

FIG. 3A to FIG. 3D are diagrams illustrating a relationship between the light emission state of the light source of the TOF camera and luminance image output. Here, the luminance image of the subject that is obtained at this time is compared with respect to four combinations of a light emission state/non-light emission state of the light source and a present state/absent state of the subject.

FIG. 3A illustrates a state in which the light source emits light, and there is the subject. The light source 11a in the light emitting unit 10 emits light, and allows the irradiation light 3a to exit toward the subject 2. The light reflected on the subject 2 is received by the two-dimensional sensor 13a in the light receiving unit 13. An output signal from the light receiving unit 13 is subjected to distance calculation by the distance calculating unit 14, and is subjected to luminance calculation by the luminance calculating unit 15, and thus, two two-dimensional images of the distance image and the luminance image are generated by the image processing unit 16 for each one frame. The distance image and the luminance image are sent to the CPU 18, and are displayed on the display device 23. Here, an example of a luminance image 40 to be displayed will be described.

The luminance image 40 visualizes the shape of the subject 2 by displaying the luminance value according to a light amount of the reflected light from the subject 2 receiving light at each of the pixel positions in the screen. A region with a large amount of reflected light is represented by a light color (a white color), and a region with a small amount of reflected light is represented by a dark color (a black color). In this example, the region of the subject (FIG. 2 is represented by a light color, and the background region is represented by a dark color. In this case, the subject 2 is shown on the luminance image 40, and thus, the sum of luminance values of the entire screen (the screen luminance value) that is calculated by the screen luminance calculating unit 20 is a large value.

FIG. 3B illustrates a state in which the light source emits light, and there is the subject. A state is obtained in which the irradiation light 3a exits from the light source 11a, but there is no reflected light from the subject. For this reason, the shape of the subject 2 is not shown on the luminance image 40, and thus, a dark image with only the reflected light from the background is obtained. In this case, the screen luminance value that is calculated by the screen luminance calculating unit 20 is a medium value.

FIG. 3C illustrates a state in which the light source does not emit light, and there is the subject. In such a state, the light source is turned off, or the light source is turned on, but the light source is abnormal, and thus, the light source 11a does not emit light, and there is no irradiation light 3a. In this case, there is only the reflected light of the external light other than the irradiation light from the subject 2. For this reason, the luminance image 40 is a dark image on which the shape of the subject 2 is slightly shown. Accordingly, the screen luminance value is a small value.

FIG. 3D illustrates a state in which the light source does not emit light, and there is no subject. In such a state, the light source is turned off, or the light source is turned on, but the light source is abnormal, and thus, the light source 11a does not emit light, and there is no irradiation light 3a. In addition, there is no reflected light itself from the subject 2. For this reason, the luminance image 40 is a dark image with only the background on which the shape of the subject 2 is not shown. Accordingly, the screen luminance value is nearly zero (0).

As described above, the screen luminance value of the luminance image 40 is changed in accordance with the light emission state/non-light emission state of the light source 11a of the TOF camera 1, and the presence/absence of the subject 2. In this example, the light emission state/non-light emission state of the light source 11a, and the presence/absence of the subject 2 are conversely determined from the calculated screen luminance value, by using such properties. Examples of a factor of a decrease in the screen luminance value include a case where the light source of the TOF camera 1 normally emits light, but there is no subject (FIG. 3B), and a case where there is abnormality in the light emission of the light source (the non-light emission, or a decrease in the light emission amount), and the subject is not capable of being sensed (FIG. 3C). Such factors are separated by separately providing a threshold value of the screen luminance value, and by comparing the calculated screen luminance value with the threshold value. Then, the light emission state of the light source is determined in a state where there is the subject. Accordingly, a failure such as the degradation of the light source can be more accurately determined.

Next, determination processing of the light emission state will be described in detail.

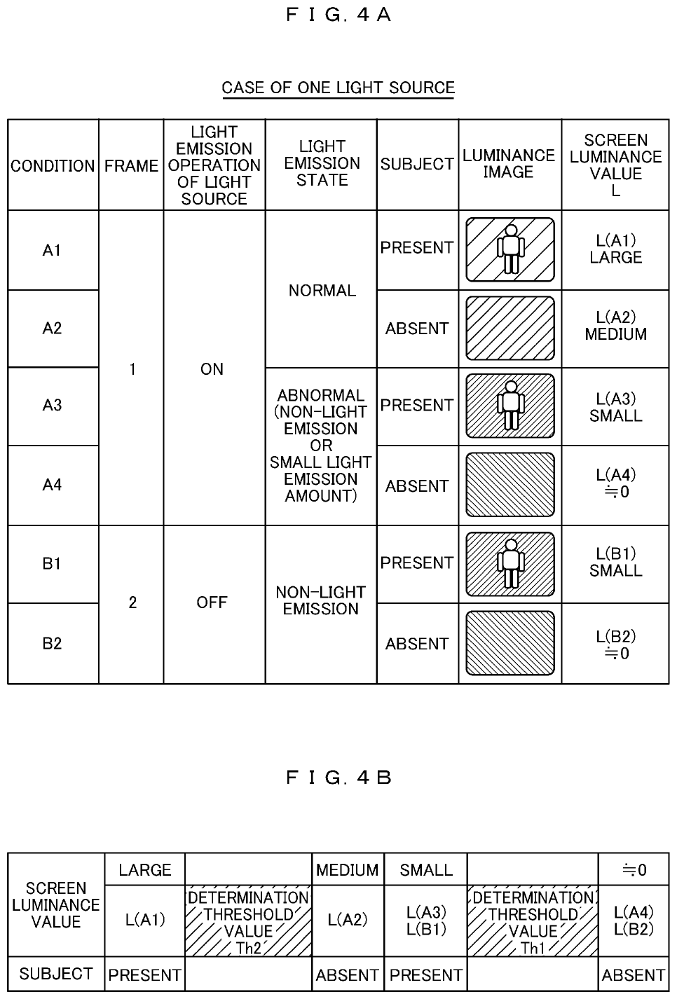

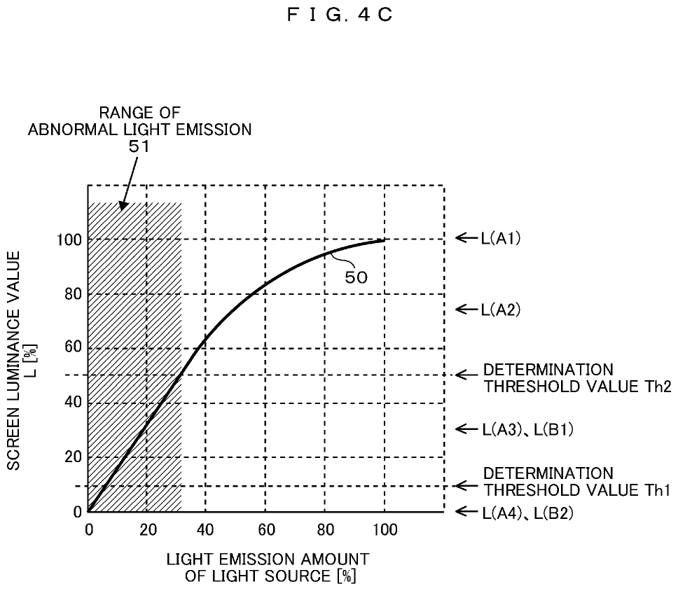

FIG. 4A is a diagram illustrating a relationship between the light emission state of the light source and the screen luminance value of the luminance image. Here, conditions are divided into A1 to A4 and B1 to B2, in accordance with ON (turning-on)/OFF (turning-off) of the light emission operation of the light source, the actual light emission state of the light source (normal light emission/abnormal light emission/non-light emission), and the presence/absence of the subject, and screen luminance values L of the luminance images in each of the conditions are represented. Note that, in order to determine the light emission state, the luminance image when the light emission operation of the light source is ON is imported in a frame 1, and the luminance image when the light emission operation of the light source is OFF is imported in a frame 2. Then, determination is performed by using the luminance image of the frame 1 and the luminance image of the frame 2.

The screen luminance values L have different levels with respect to each of the conditions A1 to A4 and B1 to B2. The condition A1 is a case where the light source normally emits light, and there is the subject, and a screen luminance value L(A1) thereof is the largest value. The condition A2 is a case where there is no subject, and there is only a background luminance, and thus, a screen luminance value L(A2) thereof is a value second to L(A1). Here, in the condition A3 and the condition B1 in which there is the subject, and the light source is abnormal or is in the non-light emission state, there is the reflected light from the subject by the external light other than the light source, and thus, screen luminance values L(A3) and L(B1) thereof are a small value. On the other hand, in the condition A4 and the condition B2 in which there is no subject, the light source is abnormal or is in the non-light emission state, and nothing is shown on the luminance image, and thus, screen luminance values L(A4) and L(B2) are a value of nearly zero (0).

Next, the presence or absence of the subject and the light emission state of the light source are determined by using the screen luminance value in the frames 1 and 2.

FIG. 4B is a diagram in which the screen luminance values L illustrated in FIG. 4A are rearranged in descending order. It is illustrated that the current operation state is separated in accordance with the size of the screen luminance value L, and it is determined that any of the conditions A1 to A4 and B1 to B2 is satisfied. In order for separation into each state, determination threshold values Th1 and Th2 of the screen luminance value L are set. Then, the presence or absence of the subject is determined by the determination threshold value Th1, and in a state where there is the subject, the light emission state (normal/abnormal) of the light source is determined by the determination threshold value Th2.

FIG. 4C is a diagram describing setting for the determination threshold values Th1 and Th2, and illustrates a relationship between the light emission amount of the light source and the screen luminance value L. As illustrated by a curve 50, the screen luminance value L decreases approximately in proportion to a decrease in the light emission amount of the light source from a normal state (100%). In addition, the screen luminance values L(A1) to L(B2) in each of the conditions of FIG. 4B are at levels (a magnitude relationship) represented on the right side of the drawing.

Here, a predetermined small value that is greater than the screen luminance values L(A4) and L(B2) when there is no subject, and the light source is abnormal or is in the non-light emission state is set as the determination threshold value Th1 of the screen luminance value L. Accordingly, in a case where both of the screen luminance values L1 and L2 of the frame 1 and the frame 2 are greater than the determination threshold value Th1, any of the conditions A1, A3, and B1 is satisfied, and it can be determined that there is the subject.

Next, the determination threshold value Th2 is used for determining the light emission state of the light source when there is the subject. First, a range 51 of the light emission amount for determining that the light emission state of the light source is abnormal is set, and the screen luminance value L at a point where the range intersects with the curve of the graph is set as the determination threshold value Th2. In the example of FIG. 4C, the light emission amount of the light source of less than or equal to 30% is set to abnormal, the screen luminance value L of 50% that is a boundary value thereof is set as the determination threshold value Th2. Accordingly, in a case where the screen luminance value L1 of the frame 1 is greater than the determination threshold value Th2, the screen luminance value corresponds to the screen luminance value L(A1), and it is determined that the light emission state is normal. In addition, in a case where the screen luminance value L1 of the frame 1 is less than the determination threshold value Th2, the screen luminance value corresponds to the screen luminance value L(A3), and it is determined that the light emission state is abnormal.

Here, an absolute value of the screen luminance value L varies in accordance with the size of the subject (an area ratio in the screen), a reflectance, or the like. Accordingly, the screen luminance value L1 of the frame 1 (at the time of turning on the light source) may be compared with the screen luminance value L2 of the frame 2 (at the time of turning off the light source), and the light emission state may be determined by the size of a difference ΔL (=L1−L2) thereof. In this case, similarly, a determination threshold value ΔTh with respect to the difference ΔL may be set and used.

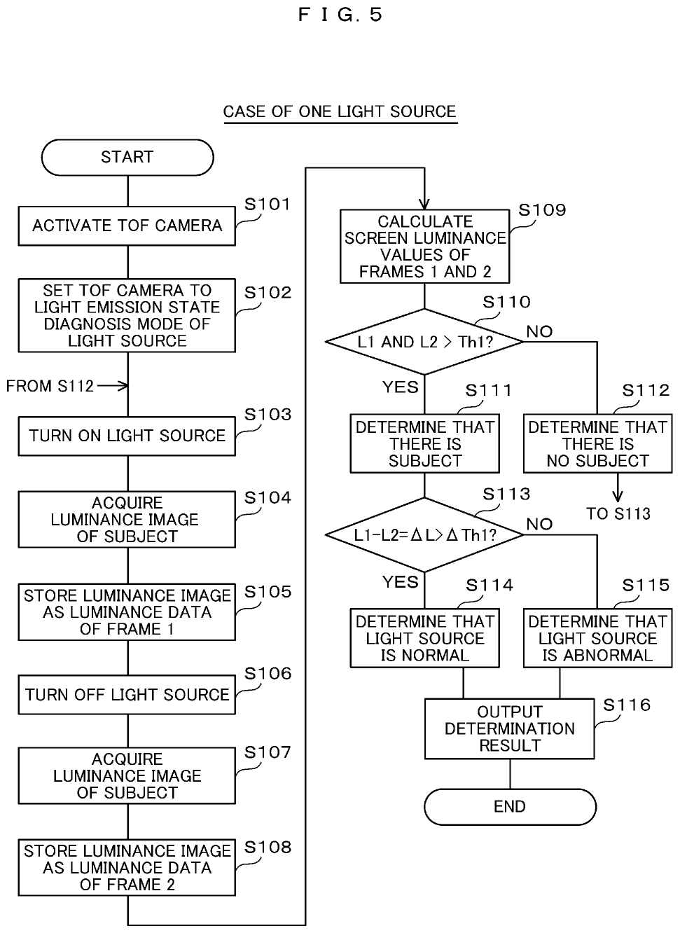

FIG. 5 is a flowchart illustrating the determination processing of the light emission state of the light source in Example 1. The determination processing described below is executed by controlling the operations of each unit of FIG. 1 with the CPU 18 (a light emission diagnosing unit) of the distance measuring device. Hereinafter, steps will be sequentially described.

S101: The TOF camera 1 is activated in accordance with a command from the CPU 18.

S102: The TOF camera 1 is set to a light emission state diagnosis mode of the light source, in accordance with the command from the CPU 18.

S103: In the TOF camera 1, the light source 11a is turned on by the light emission controlling unit 12, as processing of the frame 1.

S104: In the TOF camera 1, the reflected light from the subject is received by the light receiving unit 13, and the luminance image is acquired by the luminance calculating unit 15 and the image processing unit 16. The acquired luminance image is transmitted to the CPU 18.

S105: In the CPU 18, the received luminance image is stored in the internal memory 19, as the luminance data of the frame 1, and the processing of the frame 1 is ended.

S106: In the TOF camera 1, the light source 11a is turned off by the light emission controlling unit 12, as the processing of the frame 2.

S107: In the TOF camera 1, the reflected light from the subject is received, and the luminance image is acquired. The acquired luminance image is transmitted to the CPU 18.

S108: In the CPU 18, the received luminance image is stored in the internal memory 19, as the luminance data of the frame 2, and the processing of the frame 2 is ended.

At this time point, the luminance data at the time of turning on the light source 1 (the frame 1) and the luminance data at the time of turning off the light source 1 (the frame 2) are stored in the internal memory 19.

S109: The screen luminance calculating unit 20 of the CPU 18 calculates the screen luminance values L1 and L2 of each of the frames by using the luminance data of the frame 1 and the frame 2 stored in the internal memory 19.

S110: The light source light emission determining unit 21 determines whether or not both of the screen luminance value L1 of the frame 1 and the screen luminance value L2 of the frame 2 are greater than the determination threshold value Th1. In a case where a determination result is Yes, the processing proceeds to S111, and in a case where the determination result is No, the processing proceeds to S112.

S111: It is determined that there is the subject, the processing proceeds to S113.

S112: It is determined that there is no subject, the processing returns to S103. Then, the luminance image is acquired again, and the processing is repeated until a state is obtained in which there is the subject.

S113: In a case where there is the subject, the light source light emission determining unit 21 obtains the difference ΔL (=L1−L2) between the screen luminance values of the frame 1 and the frame 2, and determines whether or not the difference ΔL is greater than the determination threshold value ΔTh. In a case where a determination result is Yes, the processing proceeds to S114, and in a case where the determination result is No, the processing proceeds to S115.

S114: It is determined that the light emission state of the light source is normal.

S115: It is determined that the light emission state of the light source is abnormal (the non-light emission or the small light emission amount).

S116: The determination result (normal/abnormal) of the light emission state of the light source is output to the display device 23 to be displayed.

In the flow described above, in the determination of S110, both of the frame 1 and the frame 2 are regarded as if there is the subject or there is no subject, but a case can be obtained in which in only one frame, there is the subject, and in the other frame, there is no subject. Therefore, in the frame 1 and the frame 2, it may be checked that the distance image is not changed between the frames, that is, there is no change in the presence or absence of the subject by acquiring not only the luminance image but also the distance image.

In addition, in S112, when there is no subject, the processing returns to S103, and the luminance image is acquired again, but at this time, the appearance of the subject may be checked from a change in the distance images by acquiring not only the luminance image but also the distance image.

As described above, according to Example 1, the light emission state (normal/abnormal) of the light source including the presence or absence of the subject can be determined by comparing the screen luminance values of the luminance images acquired in the frame 1 (turning-on) and the frame 2 (turning-off).

### Example 2

In Example 2, a case will be described in which a plurality of light sources are used in a distance measuring device.

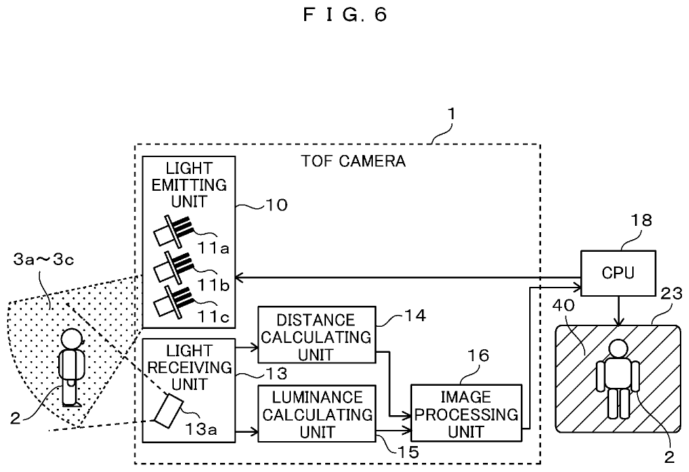

FIG. 6 is a diagram illustrating a distance measuring device and an operation state thereof in Example 2. The basic configuration of the distance measuring device is identical to that in Example 1, and a difference from Example 1 is that a plurality of light sources 11a, 11b, and 11c are disposed in the light emitting unit 10 of the TOF camera 1, and irradiation light rays 3a to 3c exit toward a subject from each of the light sources. By using the plurality of light sources, the intensity of the irradiation light can be increased, and a distance measuring accuracy can be improved. Here, in a case where there is a failure in the plurality of light sources, the intensity of the entire irradiation light may be decreased, and the distance measuring accuracy may be degraded, and thus, it is necessary to individually determine light emission states of the light sources.

Next, the details of light emission state determination processing will be described. When there are a plurality of light sources, in a first step, the presence or absence of the subject is determined, and in a second step, the light emission states of each of the light sources are determined.

<First Step> Determination of Presence or Absence of Subject

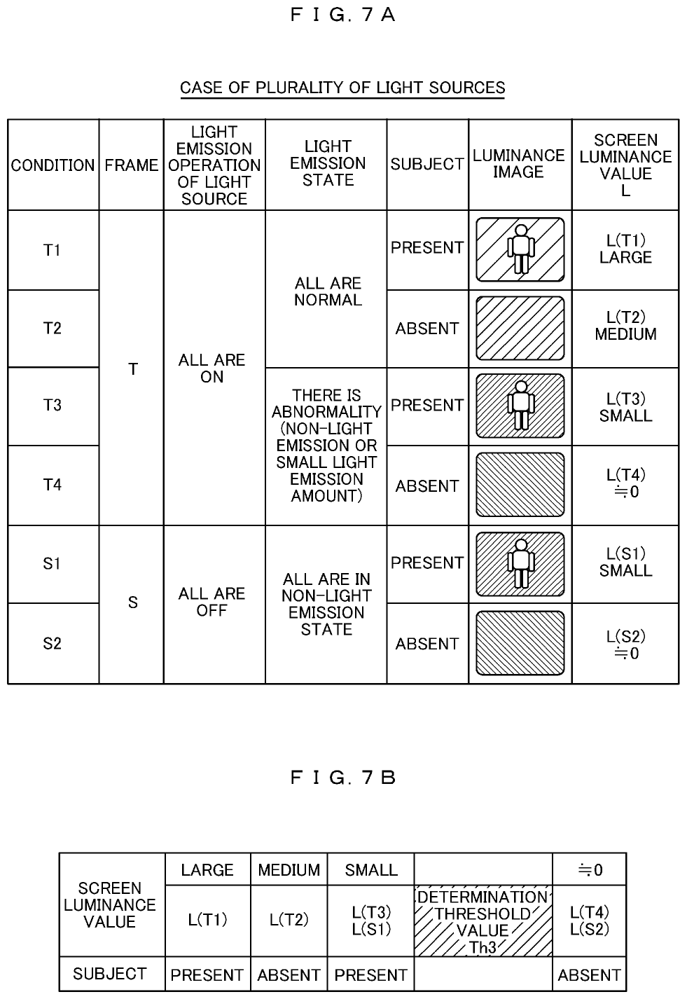

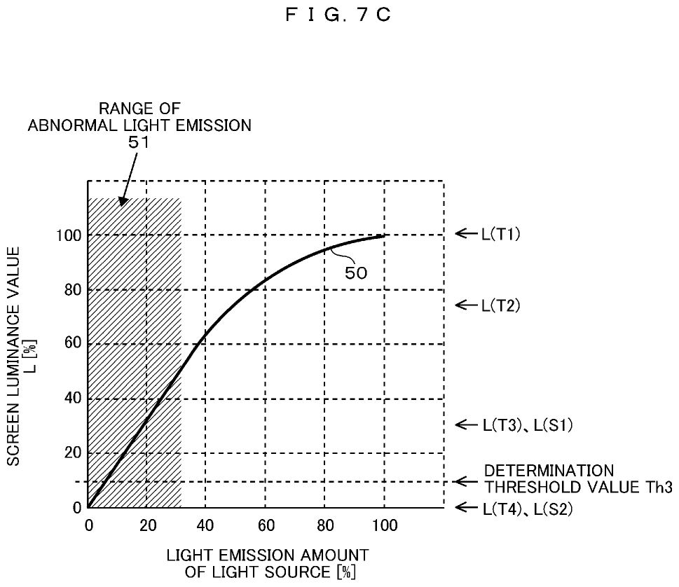

FIG. 7A is a diagram illustrating a relationship between the light emission state of the light source and a screen luminance value (the first step). Corresponding to FIG. 4A of Example 1, when light emission operations of all of the light sources are set to ON (turning-on) in a frame T, and the light emission operations of all of the light sources are set to OFF (turning-off) in a frame S, conditions are divided into T1 to T4 and S1 to S2, in accordance with the actual light emission state of the light source (normal light emission/abnormal light emission/non-light emission), and the presence/absence of the subject, and luminance images and the screen luminance values in each of the conditions are represented.

In the case of comparing the sizes of the screen luminance values L, the same tendency as that of FIG. 4A in Example 1 is obtained. That is, a screen luminance value L(T1) when all of the light sources normally emit light, and there is the subject is the largest value, and a screen luminance value L(T2) when all of the light sources normally emit light, and there is no subject is a value second to L(T2). Next, screen luminance values L(T3) and L(S1) when there is the subject, but there is abnormality in the light emission of the light source or the light source is in the non-light emission state are a small value. On the other hand, screen luminance values L(T4) and L(S2) when there is abnormality in the light emission of the light source or the light source is in the non-light emission state, and there is no subject are a value of nearly zero (0).

Next, a method for determining the presence or absence of the subject by using the screen luminance values in the frames T and S will be described.

FIG. 7B is a diagram in which the screen luminance values L illustrated in FIG. 7A are rearranged in descending order. The current operation state can be separated into the conditions T1 to T4 and S1 to S2, in accordance with the size of the screen luminance value L. In order to determine the presence or absence of the subject, a determination threshold value Th3 of the screen luminance value L is set.

FIG. 7C is a diagram describing setting for the determination threshold value Th3, and illustrates a relationship between a light emission amount of the light source and the screen luminance value L. As illustrated by a curve 50, the screen luminance value L decreases as the light emission amount of the light source decreases. In addition, the screen luminance values L in each of the conditions of FIG. 7B are at levels (a magnitude relationships) represented on the right side of the drawing.

Here, a predetermined small value that is greater than the screen luminance values L(T4) and L(S2) when there is no subject, and the light source is abnormal or is in the non-light emission state is set as the determination threshold value Th3 of the screen luminance value L. Accordingly, in a case where both of the screen luminance values L(T) and L(S) of the frame T and the frame S are greater than the determination threshold value Th3, any of the conditions T1, T2, and S1 is satisfied, and it can be determined that there is the subject.

<Second Step> Determination of Light Emission State

Next, a method for individually determining the light emission states of the plurality of light sources in a state where there is the subject will be described.

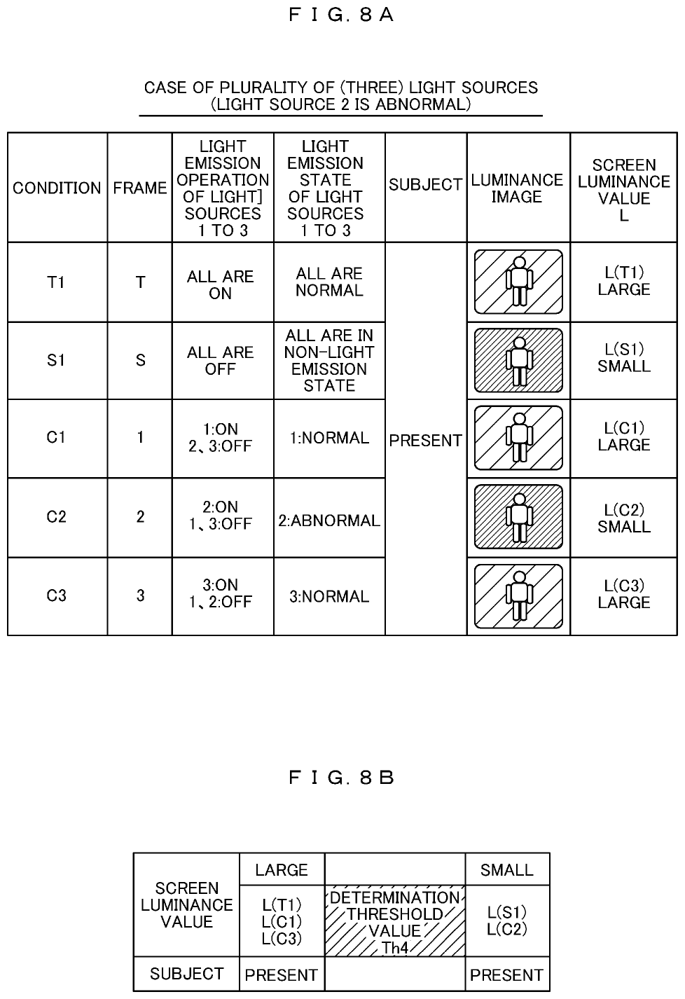

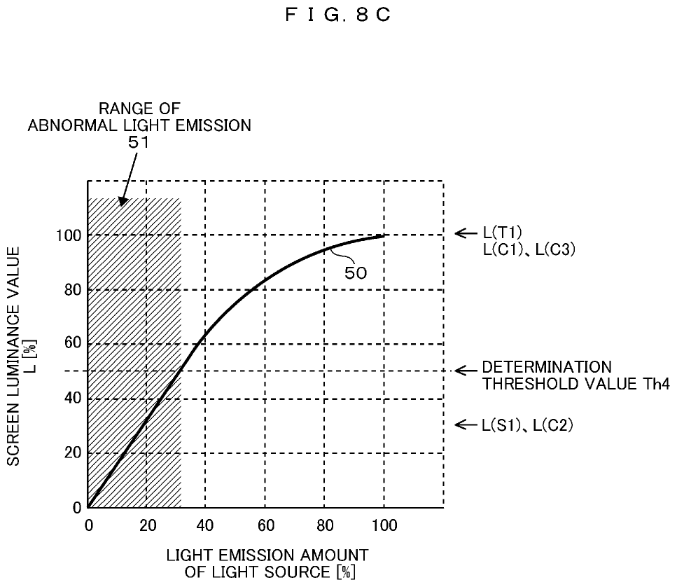

FIG. 8A is a diagram illustrating a relationship between the light emission state of the light source and the screen luminance value (the second step). In a state where there is the subject in the first step of FIG. 7A, a state where all of the light sources normally emit light (the condition T1) and a state where all of the light sources are in the non-light emission state (the condition S1) are addressed. In addition, a relationship in screen luminance values L(C1) to L(C3) is represented by adding frames 1 to 3 in a state where the light sources are turned on one by one (conditions C1 to C3). Here, there are three light sources 1 to 3, and a case is assumed in which the light emission of the light source 2 in the light sources 1 to 3 is abnormal.

In the case of comparing the sizes of the screen luminance values L, the screen luminance values L(T1), L(C1), and L(C3) when the light sources normally emit light are a large value, and the image luminance values L(S1) and L(C2) when the light sources do not emit light or are in the abnormal light emission state are a small value.

FIG. 8B is a diagram in which the screen luminance values L illustrated in FIG. 8A are rearranged in descending order. The current operation state can be separated into a group of conditions T1, C1, and C3 in which the light sources normally emit light and a group of conditions S1 and C2 in which the light sources are in the non-light emission state or the abnormal light emission state, in accordance with the size of the screen luminance value L. In order to determine such separation, a determination threshold value Th4 of the screen luminance value L is set.

FIG. 8C is a diagram describing setting for the determination threshold value Th4, and illustrates a relationship between the light emission amount of the light source and the screen luminance value L. As illustrated by a curve 50, the screen luminance value L decreases as the light emission amount of the light source decreases. In addition, the screen luminance values L in each of the conditions of FIG. 8B are at levels (a magnitude relationship) represented on the right side of the drawing.

Here, the screen luminance value L at a point where a range 51 for determining that the light emission state of the light source is abnormal intersects with the curve 50 of the graph is set as the determination threshold value Th4 of the screen luminance value L. In the example of FIG. 8C, the light emission amount of the light source of less than or equal to 30% is set to abnormal, and the screen luminance value L of 50% that is a boundary value thereof is set as the determination threshold value Th4. Accordingly, the screen luminance values L of the frame 1 to the frame 3 are compared with the determination threshold value Th4, in a case where L(C1) and L(C3) are greater than Th4, it is determined that the light emission is normal, and in a case where L(C2) is less than Th4, it is determined that the light emission is abnormal.

Here, an absolute value of the screen luminance value L varies in accordance with the size of the subject (an area ratio in the screen), a reflectance, or the like. Accordingly, the screen luminance values L(C1) to L(C3) of each of the frames 1 to 3 may be compared with the screen luminance value L(S1) of the frame S (at the time of turning off all of the light sources), the light emission state may be determined by the size of a difference ΔL thereof. In this case, similarly, a determination threshold value ΔTh with respect to the difference ΔL may be set and used.

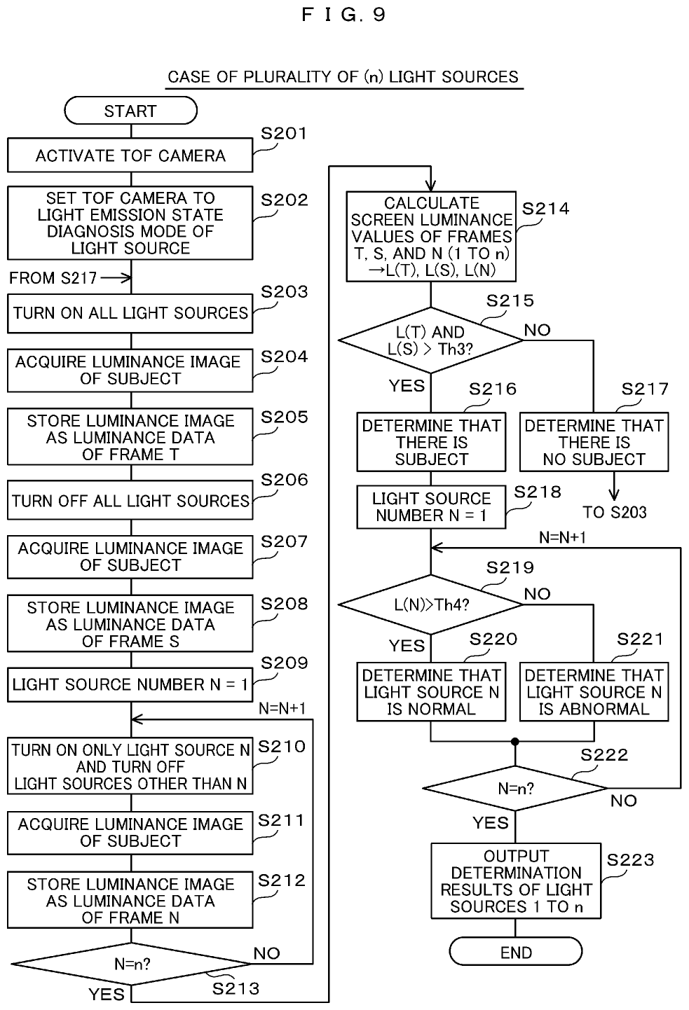

FIG. 9 is a flowchart illustrating determination processing of the light emission state of the light source in Example 2. Here, in a case where there are a plurality of (n) light sources, the first step (the determination of the presence or absence of the subject) and the second step (the determination of the light emission state) are continuously illustrated.

S201: The TOF camera 1 is activated in accordance with a command from the CPU 18.

S202: The TOF camera 1 is set to a light emission state diagnosis mode of the light source, in accordance with the command from the CPU 18.

S203: In the TOF camera 1, all of the light sources 1 to n are turned on by the light emission controlling unit 12, as processing of the frame T.

S204: In the TOF camera 1, the reflected light from the subject is received by the light receiving unit 13, and the luminance image is acquired by the luminance calculating unit 15 and the image processing unit 16. The acquired luminance image is transmitted to the CPU 18.

S205: In the CPU 18, the received luminance image is stored in the internal memory 19, as the luminance data of the frame T, and the processing of the frame T is ended.

S206: In the TOF camera 1, all of the light sources 1 to n are turned off by the light emission controlling unit 12, as processing of the frame S.

S207: In the TOF camera 1, the reflected light from the subject is received, and the luminance image is acquired. The acquired luminance image is transmitted to the CPU 18.

S208: In the CPU 18, the received luminance image is stored in the internal memory 19, as the luminance data of the frame S, and the processing of the frame S is ended.

S209: N=1 is selected as the light source number N.

S210: Only the light source N is turned on and the light sources other than N are turned off by the light emission controlling unit 12.

S211: The luminance image is acquired by the reflected light from the subject, and is transmitted to the CPU 18.

S212: In the CPU 18, the received luminance image is stored in the internal memory 19, as the luminance data of the frame N, and the processing of the frame N is ended.

S213: It is determined whether or not the light source number N reaches a total number n. In a case where a determination result is Yes, the processing proceeds to S214, and in a case where the measurement result is No, the processing returns to S210, as N=N+1. Accordingly, the luminance image is acquired until N reaches the total number n.

As a result thereof, a total of (n+2) luminance data items of the luminance data when all of the light sources are turned on (the frame T), the luminance data when all of the light sources are turned off (the frame S), and the luminance data when only the light source N (N=1 to n) is turned on (the frame N) are stored in the internal memory 19.

S214: The screen luminance calculating unit 20 of the CPU 18 calculates the screen luminance values L(T), L(S), and L(N) of each of the frames, by using the luminance data items of each of the frames that are stored in the internal memory 19.

S215: The light source light emission determining unit 21 determines whether or not both of the screen luminance value L(T) of the frame T and the screen luminance value L(S) of the frame S are greater than the determination threshold value Th3. In a case where a determination result is Yes, the processing proceeds to S216, and in a case where the determination result is No, the processing proceeds to S217.

S216: It is determined that there is the subject, and the processing proceeds to S218.

S217: It is determined that there is no subject, and the processing returns to S203. Then, the luminance image is acquired again, and the processing is repeated until a state is obtained in which there is the subject.

S218: In a case where there is the subject, the determination of the light emission state is performed with respect to each of the light sources. First, the light source number N=1 is selected.

S219: It is determined whether or not the screen luminance value L(N) of the frame N in which only the light source N is turned on is greater than the determination threshold value Th4. In a case where a determination result is Yes, the processing proceeds to S220, and in a case where the determination result is No, the processing proceeds to S221.

S220: It is determined that the light emission state of the light source N is normal.

S221: It is determined that the light emission state of the light source N is abnormal (the non-light emission or the small light emission amount).

S222: It is determined whether or not the light source number N reaches the total number n. In a case where a determination result is Yes, the processing proceeds to S223, and in a case where the determination result is No, the processing proceeds to S219, as N=N+1. Accordingly, the determination of the light emission state until N reaches the total number n is repeated.

S223: Determination results (normal/abnormal) of the light emission states of each of the light sources N (N=1 to n) are output to the display device 23 to be displayed.

As described above, according to Example 2, the light emission states of the light source 1 to the light source n can be individually determined by comparing the image luminance values of the luminance images acquired in the frame 1 to the frame n with the determination threshold value.

Note that, as a modification example of a determination method described above, a ratio (a luminance value ratio) L(N)′ may be calculated in which a sum of the luminance values of each of the frames N (N=1 to n) is set to a denominator, and the luminance values of each of the frames are set to a numerator, instead of the screen luminance values (the absolute values) of each of the frames, and may be compared with a determination threshold value Th4′. As described above, according to a comparison with a relative value, the light emission states of each of the light sources can be determined regardless of the reflectance of the subject.

According to each of the examples described above, the light emission state of the light source used in the TOF camera can be easily determined even from a remote location, the accuracy of a measurement distance can be maintained, and the convenience of the user can be improved.

Note that, the invention is not limited to the examples described above, and includes various modification examples. In addition, the examples described above have been described in detail in order to describe the invention to be easily understood, and it is not necessary to include all of the described configurations.

What is claimed is:

1. A distance measuring device outputting a position of a subject as a distance image, the device comprising:
a light emitting unit that allows a light source to emit light and irradiates the subject with the light;
a light receiving unit that receives reflected light from the subject;
a distance calculating unit that calculates a distance to the subject from a detection signal of the light receiving unit;
a luminance calculating unit that calculates a luminance of the subject from the detection signal of the light receiving unit;
an image processing unit that generates a distance image of the subject from the distance calculated by the distance calculating unit and generates a luminance image of the subject from the luminance calculated by the luminance calculating unit;
a screen luminance calculating unit that calculates screen luminance values of each frame from the generated luminance image; and
a light source light emission determining unit that determines whether a light emission state of the light source is normal or abnormal by using the screen luminance values of each of the frames,
wherein the light source light emission determining unit determines the light emission state of the light source by acquiring a screen luminance value L1 at the time of turning on the light source in a first frame, by acquiring a screen luminance value L2 at the time of turning off the light source in a second frame, and by comparing the screen luminance values L1 and L2 of the first frame and the second frame.

2. The distance measuring device according to claim 1,
wherein the light source light emission determining unit determines that there is the subject in the luminance image when both of the screen luminance values L1 and L2 of the first frame and the second frame are greater than a threshold value Th1, and
determines that the light emission state of the light source is normal when the screen luminance value L1 of the first frame is greater than a threshold value Th2, and determines that the light emission state of the light source is abnormal when the screen luminance value L1 is less than the threshold value Th2.

3. The distance measuring device according to claim 1,
wherein the light source light emission determining unit determines that there is the subject in the luminance image when both of the screen luminance values L1 and L2 of the first frame and the second frame are greater than a threshold value Th1, and
determines that the light emission state of the light source is normal when a difference ΔL (=L1−L2) between the screen luminance value L1 of the first frame and the screen luminance value L2 of the second frame is greater than a threshold value ΔTh, and determines that the light emission state of the light source is abnormal when the difference ΔL is less than the threshold value ΔTh.

4. A distance measuring device outputting a position of a subject as a distance image, the device comprising:
a light emitting unit that allows a plurality of (n) light sources to emit light and irradiates the subject with the light;
a light receiving unit that receives reflected light from the subject;
a distance calculating unit that calculates a distance to the subject from a detection signal of the light receiving unit;
a luminance calculating unit that calculates a luminance of the subject from the detection signal of the light receiving unit;
an image processing unit that generates a distance image of the subject from the distance calculated by the distance calculating unit and generates a luminance image of the subject from the luminance calculated by the luminance calculating unit;
a screen luminance calculating unit that calculates screen luminance values of each frame from the generated luminance image; and
a light source light emission determining unit that determines whether a light emission state of the light source is normal or abnormal by using the screen luminance values of each of the frames,
wherein the light source light emission determining unit individually determines the light emission states of the light sources by acquiring a screen luminance value L(T) at the time of turning on all of the light sources in a frame T, by acquiring a screen luminance value L(S) at the time of turning off all of the light sources in a frame S, by acquiring a screen luminance value L(N) at the time of turning on an N-th light source and of turning off the other light sources in a frame N (N=1 to n), and by comparing the screen luminance values L(T), L(S), and L(N) of each of the frames T, S, and N.

5. The distance measuring device according to claim 4,
wherein the light source light emission determining unit determines that there is the subject in the luminance image when both of the screen luminance values L(T) and L(S) of the frames T and S are greater than a threshold value Th3, and
determines that the light emission state of the N-th light source is normal when the screen luminance value L(N) of the frame N is greater than a threshold value Th4, and determines that the light emission state of the N-th light source is abnormal when the screen luminance value L(N) is less than the threshold value Th4.

6. The distance measuring device according to claim 4,
wherein the light source light emission determining unit determines that there is the subject in the luminance image when both of the screen luminance values L(T) and L(S) of the frames T and S are greater than a threshold value Th3,
obtains a luminance value ratio L(N)′ in which the screen luminance value L(N) of the frame N is added from N=1 to N=n to be a denominator, and the screen luminance value L(N) of the frame N is set to a numerator, and
determines that the light emission state of the N-th light source is normal when the screen luminance value ratio L(N)′ of the frame N is greater than a threshold value Th4′, and determines that the light emission state of the N-th light source is abnormal when the screen luminance value ratio L(N)′ is less than the threshold value Th4′.

7. The distance measuring device according to claim 1,
wherein the screen luminance calculating unit uses a sum or an average value of luminance values of all ranges of the luminance images acquired in each of the frames or a sum or an average value of luminance values of predetermined ranges of the luminance images acquired in each of the frames at the time of calculating the screen luminance values of each of the frames.

8. A light emission diagnosis method for a light source used in a distance measuring device, the method comprising:
a step of receiving reflected light from a subject by turning on the light source to generate a luminance image of the subject in a first frame;
a step of receiving the reflected light from the subject by turning off the light source to generate the luminance image of the subject in a second frame;
a step of acquiring screen luminance values L1 and L2 of each of the frames from the generated luminance images; and
a step of determining whether a light emission state of the light source is normal or abnormal by using the screen luminance values L1 and L2 of each of the frames,
wherein it is determined that there is the subject in the luminance image when both of the screen luminance values L1 and L2 of the first frame and the second frame are greater than a threshold value Th1, and
it is determined that the light emission state of the light source is normal when the screen luminance value L1 of the first frame is greater than a threshold value Th2, and it is determined that the light emission state of the light source is abnormal when the screen luminance value L1 is less than the threshold value Th2.

9. A light emission diagnosis method for a plurality of (n) light sources used in a distance measuring device, the method comprising:
a step of receiving reflected light from a subject by turning on all of the light sources to generate a luminance image of the subject in a frame T;
a step of receiving the reflected light from the subject by turning off all of the light sources to generate the luminance image of the subject in a frame S;
a step of receiving the reflected light from the subject by turning on an N-th light source and by turning off the other light sources to generate the luminance image of the subject in a frame N (N=1 to n);
a step of acquiring screen luminance values L(T), L(S), and L(N) of each of the frames from the generated luminance images; and
determining whether the light emission state of the light source is normal or abnormal by using the screen luminance values L(T), L(S), and L(N) of each of the frames,
wherein it is determined that there is the subject in the luminance image when both of the screen luminance values L(T) and L(S) of the frames T and S are greater than a threshold value Th3, and
it is determined that the light emission state of the N-th light source is normal when the screen luminance value L(N) of the frame N is greater than a threshold value Th4, and it is determined that the light emission state of the N-th light source is abnormal when the screen luminance value L(N) is less than the threshold value Th4.

10. The light emission diagnosis method for a plurality of light sources according to claim 8,
wherein when it is determined that there is no subject in the luminance image by the screen luminance values of each of the frames, the luminance images of each of the frames are acquired again, and the steps are repeated until a state is obtained in which there is the subject.
